(19) United States
(12) Patent Application Publication
(10) Pub. No.: US 2016/0217636 A1
(43) Pub. Date: Jul. 28, 2016

(54) ACCESS CONTROL DEVICE AND ACCESS CONTROL METHOD

(71) Applicant: HON HAI PRECISION INDUSTRY CO., LTD., New Taipei (TW)

(72) Inventors: YI-RU LAI, New Taipei (TW); SHU-MING LIU, New Taipei (TW); CHIA-JUNG LIU, New Taipei (TW)

(21) Appl. No.: 14/615,985

(22) Filed: Feb. 6, 2015

(30) Foreign Application Priority Data
Jan. 26, 2015 (TW) 104102442

(51) Int. Cl. G07C 9/00

(52) U.S. Cl. CPC G07C 9/00126

(57) ABSTRACT

Access control device includes a first electronic device and a second electronic device. The first electronic device includes a storing module and a processing module. The storing module stores an information about the visitor, and the processing module processes the information to generate an identification figure. The second electronic device includes an executing module, and the executing module determines an access permission about the visitor for entering into a restricted zone, according to the identification figure. The disclosure further provides an access control method.

### FIELD

The subject matter herein generally relates to an access control device and an access control method.

### BACKGROUND

A factory includes many restricted zones, and a visitor needs permission to enter into the restricted zones. Usually, an access control device includes an IC/ID card or a fingerprint for obtaining the access permission to enter into the restricted zones.

### BRIEF DESCRIPTION OF THE DRAWINGS

Implementations of the present technology will now be described, by way of example only, with reference to the attached figures.

FIG. 1 is a block diagram of one embodiment of function modules of an access control device.

FIG. 2 is a flowchart of one embodiment of an access control method using the access control device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

The present disclosure is described in relation to an access control device. The access control device includes a first electronic device and a second electronic device. The first electronic device includes a storing module and a processing module. The storing module stores information about a visitor and the processing module processes the information to generate an identification figure. The second electronic device includes an executing module, and the executing module determines an access permission about the visitor for entering into a restricted zone, according to the identification figure.

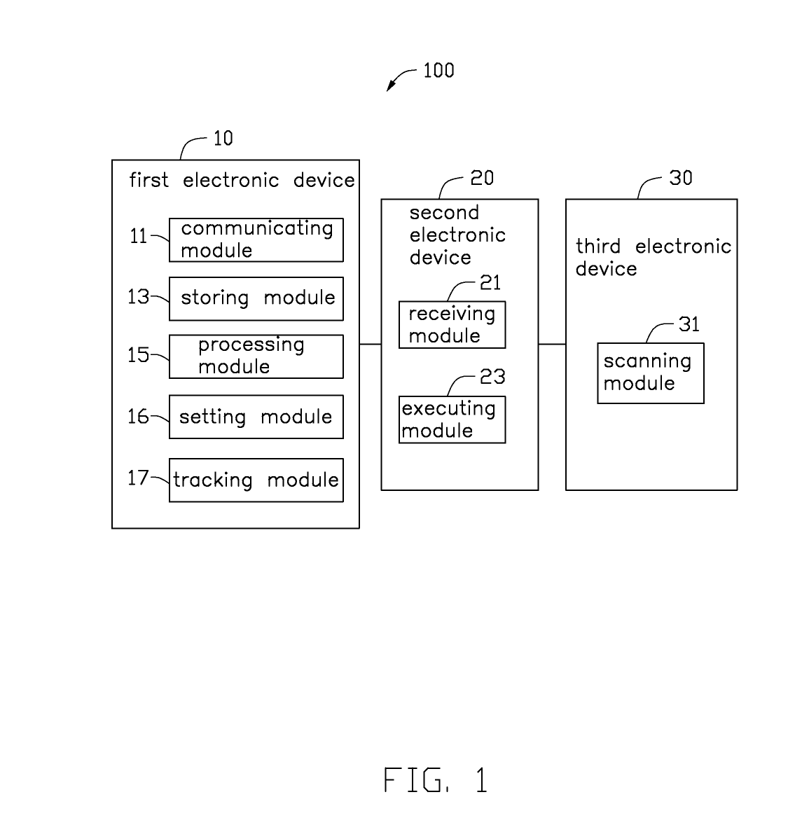

FIG. 1 illustrates an embodiment of an access control device 100. The access control device 100 can include a first electronic device 10, a second electronic device 20 and a third electronic device 30.

The first electronic device 10 can include a communicating module 11, a storing module 13, a processing module 15, a setting module 16, and a tracking module 17. The communicating module 11 is configured to connect a network to receive information about a visitor for the storing module 13. For example, when the first electronic device 10 is operated by the visitor, the information can be input into the first electronic device 10 via a display of the first electronic device 10. The information can include a name, a gender, an identification card number, a telephone number, a fingerprint, and other information used for distinguishing from other visitor information. The storing module 13 is configured to store the information about the visitor. The processing module 15 is configured to process the information about the visitor to generate an identification figure. The identification figure can be a barcode or an image. The setting module 16 is configured to set a deadline of the identification figure. For example, the deadline of the identification figure is one day, so the identification figure can be valid only one day. The tracking module 17 is configured to track the geographical location about the visitor to allow the first electronic device 10 to detect the geographical location about the visitor. In at least one embodiment, the first electronic device 10 is a terminal having a display, such as a personal computer.

The second electronic device 20 can include a receiving module 21 and an executing module 23. The receiving module 21 is configured to receive the identification figure from the processing module 15 for sending to the executing module 23. In at least one embodiment, the receiving module 21 can be a camera of the second electronic device 20, and the second electronic device 20 can store the identification figure via the camera taking a picture of the identification figure. The executing module 23 can determine an access permission about the visitor according to the identification figure. In at least one embodiment, the second electronic device 20 can be a portable device, such as a mobile phone or a tablet computer.

The third electronic device 30 can include a scanning module 31. The scanning module 31 is configured to scan the barcode of the identification figure to allow the executing module 23 to execute access permissions about the visitor. For example, the scanning module 31 scans the barcode, if the information about the visitor displayed by the scanning module 31 is satisfied with an authorized information, the visitor is permitted to access a restricted zone; if the information about the visitor displayed by the scanning module 31 is not satisfied with the authorized information, the visitor cannot be permitted to access the restricted zone. When the scanning module 31 is scanning the barcode, the tracking module 17 tracks the geographical location about the visitor to allow the first electronic device 10 to know the geographical location about the visitor.

The third electronic device 30 does not exist in the access control device 100. For example, the processing module 15 can generate an image according to the information about the visitor, and when the image is used to be seen by a security guard, the security guard can determine whether the visitor is permitted to access the restricted zone. If the image has the authorized information, the visitor is permitted to access the restricted zone by the security guard; if the image does not have the authorized information, the visitor cannot be permitted to access the restricted zone by the security guard.

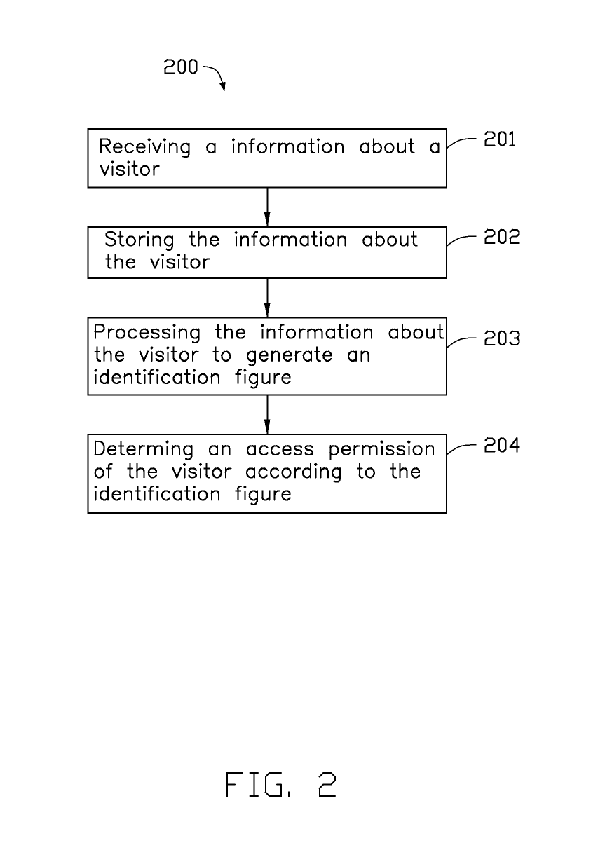

Referring to FIG. 2, a flowchart is presented in accordance with an example embodiment which is being thus illustrated. The example method 200 is provided by way of example, as there are a variety of ways to carry out the method. The method 200 described below can be carried out using the configurations illustrated in FIG. 1, for example, and various elements of these figures are referenced in explaining example method 200. Each block shown in FIG. 2 represents one or more processes, methods or subroutines, carried out in the exemplary method 200. Furthermore, the illustrated order of blocks is by example only and the order of the blocks can change according to the present disclosure. Additional blocks may be added or fewer blocks may be utilized, without departing from this disclosure. The exemplary method 200 can begin at block 201.

At block 201, the communicating module 11 receives information of a visitor for the storing module 13. For example, when the first electronic device 10 is operated by the visitor, the information can be input into the first electronic device 10 via a display of the first electronic device 10. The information can include a name, a gender, an identification card number, a telephone number, a fingerprint, and other information used for distinguishing other visitor information.

At block 202, the storing module 13 stores the information about the visitor.

At block 203, the processing module 15 processes the information about the visitor to generate an identification figure. The identification figure can be a barcode or an image.

At block 204, the executing module 23 determines an access permission about the visitor according to the identification figure. For example, when the identification figure is a barcode, the scanning module 31 of the third electronic device 30 scans the barcode, and if the information about the visitor has authorized information, the visitor is permitted to access a restricted zone; if the information about the visitor does not have the authorized information, the visitor is not permitted to access the restricted zone. When the identification figure is an image, the security guard can determine whether the visitor is permitted to access the restricted zone. If the image has the authorized information, the visitor is permitted to access the restricted zone by the security guard; and if the image is does not have the authorized information, the visitor is not permitted to access the restricted zone by the security guard.

The embodiments shown and described above are only examples. Many details are often found in the art such as the other features of an access control device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An access control device comprising:
a first electronic device comprising:
a storing module; configured to store information about a visitor; and
a processing module configured to process the information to generate an identification figure; and
a second electronic device comprising an executing module, the executing module configured to determine an access permission about the visitor for entering a restricted zone, according to the identification figure.

2. The access control device of claim 1, wherein the first electronic device further comprises a communicating module, and the communicating module is configured to connect a network to receive the information for the storing module.

3. The access control device of claim 1, wherein the second electronic device further comprises a receiving module, and the receiving module is configured to receive the identification figure from the processing module for sending to the executing module.

4. The access control device of claim 3, wherein the receiving module is a camera of the second electronic device, and the second electronic device is configured to store the identification figure by the camera.

5. The access control device of claim 1, wherein the first electronic device further comprises a setting module, and the setting module is configured to set a deadline of the identification figure.

6. The access control device of claim 1, wherein the first electronic device further comprises a tracking module, and the tracking module is configured to track the geographical location about the visitor to allow the first electronic device to know the geographical location about the visitor.

7. The access control device of claim 1, further comprising a third electronic device, wherein the identification figure comprises a barcode, the third electronic device comprises a scanning module, and the scanning module is configured to scan the barcode to allow the executing module to determine the access permission about the visitor for entering into a restricted zone.

8. The access control device of claim 1, wherein the identification figure comprises an image, and the image is configured to allow the executing module to determine the access permission about the visitor for entering into a restricted zone.

9. The access control device of claim 1, wherein the second electronic device is a mobile phone or a tablet computer.

10. An access control method comprising:
storing, by a storing module of a first electronic device, information about a visitor;
processing the information, by a processing module of the first electronic device, to generate an identification figure; and
determining, by an executing module of a second electronic device, an access permission about the visitor for entering a restricted zone, according to the identification figure.

11. The access control method of claim 10, further comprising: connecting a network to receive the information for the storing module by a communicating module of the first electronic device.

12. The access control method of claim 10, further comprising: receiving the identification figure from the processing module for sending to the executing module by the second electronic device.

13. The access control method of claim 12, wherein the receiving module is a camera of the second electronic device, and the accessing control method further comprising: storing the identification figure by the camera.

14. The access control method of claim 10, further comprising: setting a deadline of the identification figure by a setting module of the first electronic device.

15. The access control method of claim 10, wherein tracking the geographical location about the visitor to allow the first electronic device to know the geographical location about the visitor by a tracking module of the first electronic device.

16. The access control method of claim 10, wherein the identification figure comprises a barcode, and the accessing control method further comprising: scanning the barcode to allow the executing module to determine the access permission about the visitor for entering into a restricted zone by a scanning module of a third electronic device.

17. The access control method of claim 10, wherein the second electronic device is a mobile phone or a tablet computer.
